(19) United States
(12) Patent Application Publication
(10) Pub. No.: US 2025/0324924 A1
(43) Pub. Date: Oct. 23, 2025

(54) Bale Claw

(71) Applicant: Chris Whinery, Bixby, OK (US)

(72) Inventor: Chris Whinery, Bixby, OK (US)

(21) Appl. No.: 18/445,966

(22) Filed: Apr. 18, 2024

(51) Int. Cl. A01D 87/00

(52) U.S. Cl. CPC A01D 87/003

(57) ABSTRACT

A hay claw is an agricultural tool used to transport and cover hay bales from weather issues, the hay claw providing a shaft with an upper end forming a loop or engagement location and a lower end of the shaft forming a plurality of talons depending from a common origin and forming respective upward oriented points to penetrate and engage the hay bale for lifting point for lifting and transport or for providing a plurality of anchor points to secure a tarp over one or more hay bales otherwise exposed to the elements.

### BACKGROUND OF THE INVENTION

### 1. Field of Invention

An agricultural device for lifting and securing tarps to large baled hay products providing one or more hay claws defining a plurality of rigid tine members directed substantially parallel to one another extending from a common tine support member at a lower end and perpendicular to an upper connecting handle forming an upper eyelet, to which a single or double ended strap is attached to elevate a hay bale upward by the strap or attaching an elastic tie-down or rope to secure a tarp or plastic cover over one or more hay bales to protect the hay bales from weather conditions and decay during long term outdoor ground storage.

### 2. Description of Prior Art

A preliminary review of prior art patents was conducted by the applicant which reveal prior art patents in a similar field or having similar use. However, the prior art inventions do not disclose the same or similar elements as the present multiple purpose hay bale hook and lift members, nor do they present the material components in a manner contemplated or anticipated in the prior art.

In AU 2008/207490 to Snowden, a bale cover system protects one or more hay bales by securing a tarp on the upper surface of an uppermost hay bale in a stack with raised structures on the side edges to repel and channel water from the top bale. FIG. 9 demonstrates a metal cord gathering device to lock and hold a rope which engages the tarp. In U.S. Pat. No. 2,962,177 to Pridgeon, a hydraulic hood device has remotely operating hay hook grapples which grab one or more bales to either remove them from a stack or place them upon a stack of hay bales. The hook grapples indicate a plurality of aligned tines forming a parallel curved penetration member which rotate into place at the direction of the operator. In Duenow, U.S. Pat. No. 4,367,062, an overhead claw combines with a lower fixed spike to engage a round bale for mobile transport and positioning using a plurality of claw-like structures which engage a hay bale at several outer perimeter points being driven into the hay bale.

The Jones Patent Application Publication No. 2022/0279725, discloses a plurality of parallel horizontal spike members attached to a three-point hitch of a tractor which pierce a square hay bale and lift the hay bale for transport to another location, each tine bearing a portion of the overall weight of the bale during the transport. Bach, U.S. Pat. No. 9,428,096, discloses a hay strapping hook to position and hold a strap straight in place over rows of hay stacks or bails on a trailer until the strap is secured in place, to hold alignment during the strap tightening process to secure the load. The headpiece of the hay strap hook is embodied as an H-shaped piece with two depending lower arms terminating in a pointed end to penetrate the hay bale surface during strap application.

None of the prior art patent, alone or in combination, disclose a hay bale hook and lift member providing a plurality of aligned shape tines which penetrate a hay bale on any surface for engagement with a strap for lifting of a compressed or uncovered spooled hay bale for transport and also the hook and lift member providing for attachment or one or more weather-resistant full or partial hay bale covers lying in and exposed position to weather for storage or exterior feeding of livestock.

### SUMMARY OF THE INVENTION

Hay bales, especially the large round variety, are commonly move about from the hay field to storage locations for supplemental feeding of livestock by farm implements or hay trucks. This is conducted with the aid of hay spikes or fork lifts that elevate the hay bale for ground transport between location during storage and also during feed transport. Hay is stored either in covered storage sheds, barn lofts or outdoors on the ground, either rest or lie on the ground or in elevated stacks until needed in the future. In a covered storage sheds and lofts, bales are protected from the elements. Outdoors, the bales are exposed to sun, rain and snow which can cause the hay to decay and to absorb moisture unless covered by tarps or plastic sheets which divert and deflect moisture from above.

The bale claw is a simple object which is used for an alternative bale transport tool for use with a tractor having a front end loading attachment, utilizing the bale claw combined with a rope or inflexible strap to transport the bale or using the bale claw to secure a tarp cover using a rope or elastic strap or bungee cord attached to the bale claw. This is useful when placing a bale in a hay feeding ring, hay cradle or hay feeder, whether the bale is fully bound, partially bound or unbound and whether the bales are square, round, large or small.

### DESCRIPTION OF THE DRAWINGS

The following drawings are submitted with this utility patent application.

FIG. 1 is a front view of the hay claw.

FIG. 2 is a right front side perspective view of the hay claw.

FIG. 3 is a left side view of the hay claw.

FIG. 4 is a view of a hay claw and connected flexible strap engaging a round bale lifted by a strap with a tractor front end lift member.

FIG. 5 is a side view of a pair of hay claws and a common strap to secure an unbound round bale together while being transported by a tractor with the unbound hay bale impaled upon a hay spike.

FIG. 6 is a series of hay bales covered by a common tarp cover and secured over the hay bales by a plurality of hay claws and a threaded cinch rope or elastic bungees.

### DESCRIPTION OF THE PREFERRED EMBODIMENT

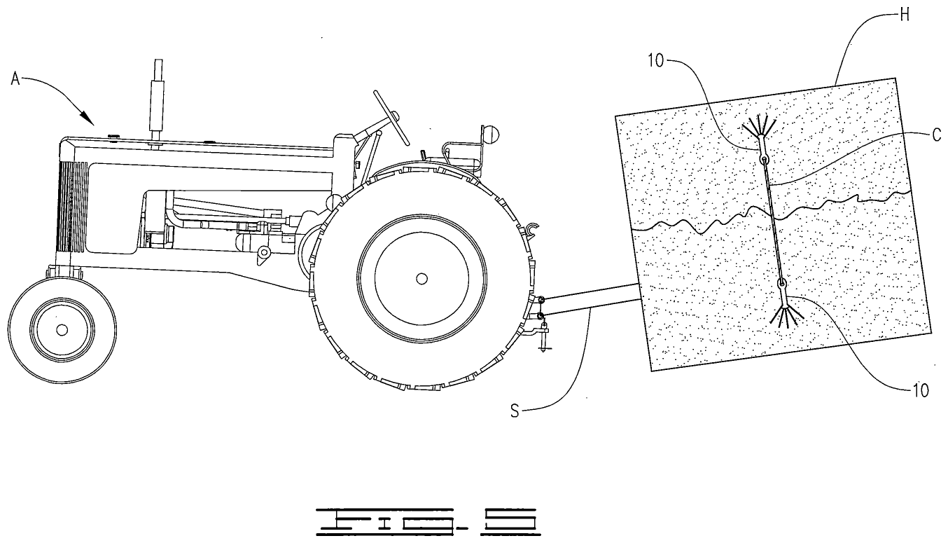

In agriculture, hay has always been a primary source of supplemental livestock feed, especially during the time of year where graze grasses are dormant or scarce due to drought. Desirable grasses and high protein plants are cut, dried and baled in sizes that vary from small individual bales or very large round and squared bales, which are compacted and bound by string, twine, wire or wraps, depending on the baling equipment used. Once baled, the hay products are moved to a location for short and long term storage or for mobile transport and sale. Transport from the point of harvest to the point of storage or sale requires handling of the bales by either an individual to load and unload the bales, or for larger bales, other farm equipment, including tractors (FIG. 4) with spikes to piece and lift the bales or other front and rear loading equipment. Most frequently, farm equipment is used to transport the bales from and storage location to a stock feeding location or to a location for use as stall bedding material.

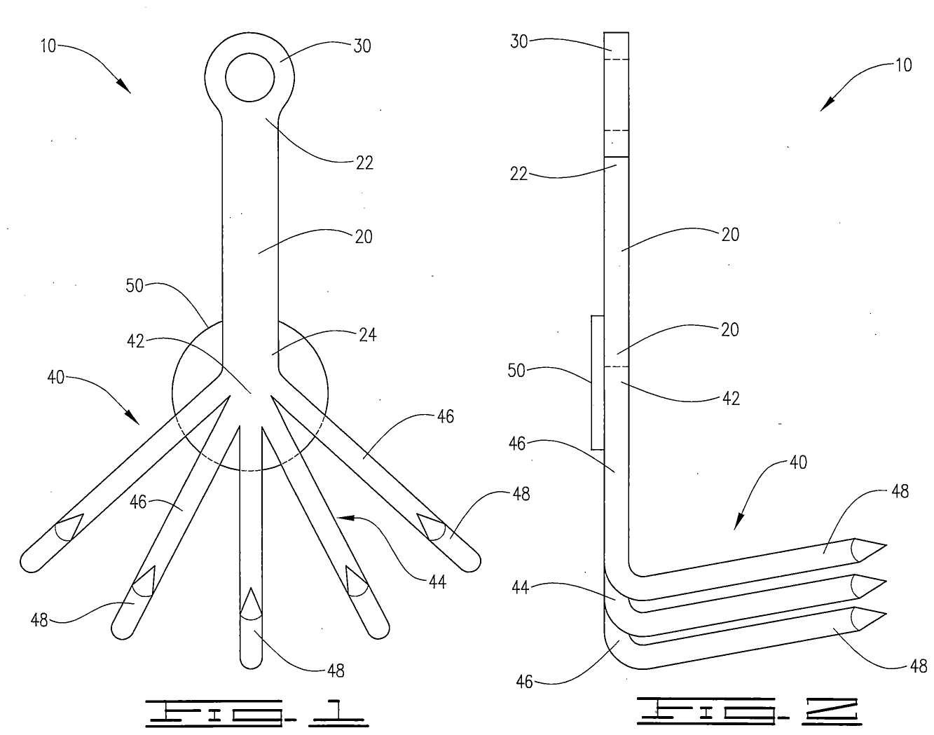

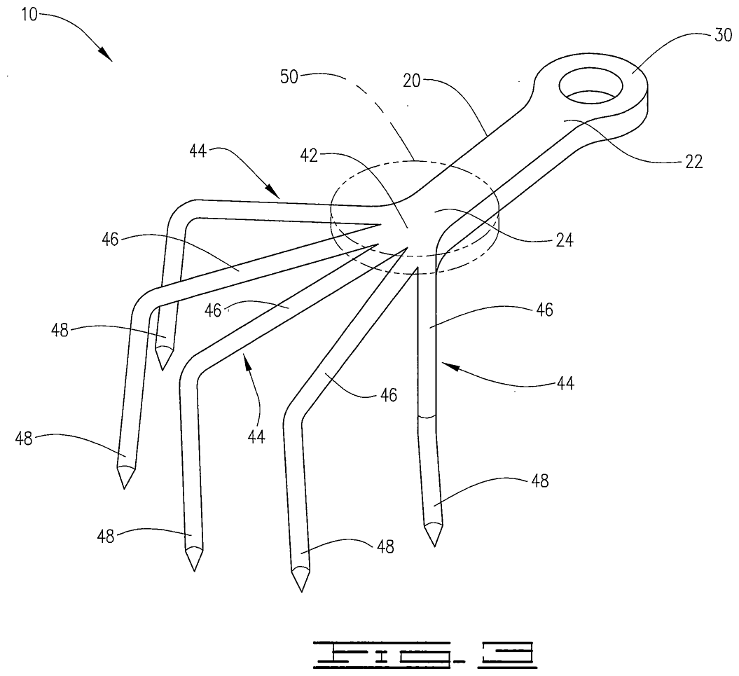

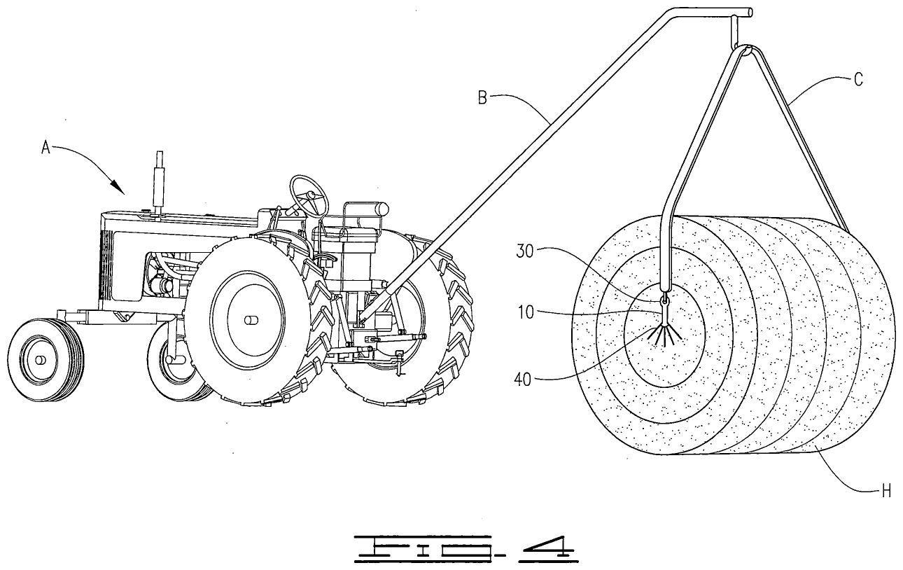

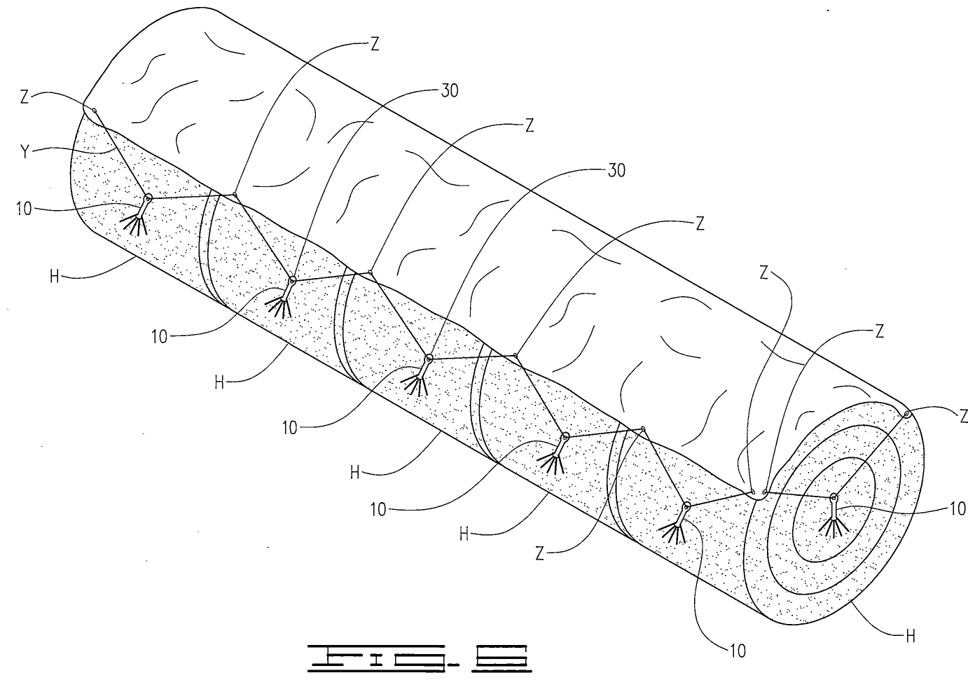

The present bale claw 10, FIGS. 1-3, is a utility tool which is used to form at least one immediate grip point into a hay bale H which is readily installed and removed. The bale claw 10 is used to provide at least two grip points for lifting the hay bale H (FIG. 4) or one point to anchor a section of a tarp X or outdoor weather-proof cover to protect on or more hay bales H stored outdoors (FIG. 5). The bale claw 10 defines a shaft 20 having an upper end 22 defining a loop 30 and a lower end 24 defining a claw 40 having a plurality of curved talons 44 spread apart, emanating from a common origin junction 42 at the lower end 24, each talon 44 forming a depending stem 46 with an upward angled pointed penetration tip 48 as shown in FIGS. 1-3. These talons 44 are spread apart to provide multiple bale engagement points to distribute the spread of the talons 44 for maximum gain into the locations of the bale where each bale claw 10 is placed. A strike plate 50 may be included, as shown in FIGS. 1-3, to use a hammer to drive the talons into a hay bale that is tightly wound or through a sheath, not shown, wrapping the hay bale H.

As shown in FIG. 4, the bale claws 10 attach a strap C within each loop 30 on at least two bale claws 10, providing a tractor A with an upper lift mechanism B attached to a tractor three point hitch of front end loader with the capability to lift and manipulate a hay bale H. An unbound hay bale H may also be transported as shown in FIG. 5, where a hay spike S extends from the tractor A with a pair of bale claws 10 spanning the unbound hay bale H to keep the hay within the hay bale H from unraveling or despooling during transport.

In FIG. 6, a common tarp X is used to cover several aligned bales H, while numerous bale claws 10 are installed within the aligned bales H using a rope Y to lace grommets Z within the tarp X and the loops 30 of each bale claw 10 to secure the tarp X to the hay bales during storage. The rope Y can be unlaced to expose each bale H as used over time, with the hay claw 10 reinstalled and re-laced for further storage protection.

For light use, the hay claw 10 can be made of a durable polymer and casted or molded. For the more aggressive use, including lifting large bales H as shown in FIG. 4, it would be made of a welded or cast metal material suitable to lift the weight of the larger bales H during transport or loading. The strap C lifting may be more suitable for some type of loading on large hay wagons or linear trough haulers because the bale can be manipulated at 360 degrees as opposed to having a one direction loading pathway more common in single or dual spike manipulation. It also provides for the ability to transport unbound bales to different locations or hay feeding rings, troughs or mangers.

While the hay claw 10 has been particularly shown and described with reference to a preferred embodiment thereof, it will be understood by those skilled in the art that changes in form and detail may be made therein without departing from the spirit and scope of the invention.

1. A hay claw for transporting hay bales and also to serve as an attachment point for weather resisting tarps or fabric covers to protect exposed hay bales from weather elements while store, said hay claw comprising:
a shaft having an upper end defining a loop;
said shaft having a lower end extending a claw defining an origin junction depending a plurality of talons, each said talon further defining a stem with an upward extending penetration tip which may penetrate one or more surfaces of said hay bale to removably engage said hay bale for lifting or for providing an anchor point for other attachment.

2. A method for using said hay claw as defined in claim 1, wherein at least two said bale claws are installed on a surface of a hay bale with said loop attached to a common strap or rope for lifting said bale for transport by a tractor having a lift mechanism from different locations without disruption to the integrity of said hay bale.

3. The a method for using said hay claw of claim 1 further providing a plurality of hay claws inserted into a surface of a plurality of aligned hay bales, wherein said common tarp or fabric cover defining a plurality of margin grommets and using a length of cord, bungees or ropes, provides weather-proof protection to said plurality of aligned hay bales by lacing said cord, bungees or ropes through said plurality of grommets and said loops of said hay claws to secure said common tarp or fabric covering during a time between placement and feeding of said hay bale at a feeding location.
